(19) United States
(12) Patent Application Publication
(10) Pub. No.: US 2018/0275008 A1
(43) Pub. Date: Sep. 27, 2018

(54) SYSTEM AND METHOD FOR THE ULTRASONIC AUTONOMOUS DETECTION OF LEAKS

(71) Applicant: ExxonMobil Research and Engineering Company, Annandale, NJ (US)

(72) Inventor: Patrick E. Goschy, Houston, TX (US)

(21) Appl. No.: 15/918,490

(22) Filed: Mar. 12, 2018

Related U.S. Application Data
(60) Provisional application No. 62/475,959, filed on Mar. 24, 2017.

(51) Int. Cl. G01M 3/04; G08B 21/18

(52) U.S. Cl. CPC G01M 3/04; G08B 21/18

(57) ABSTRACT

A system and method for the ultrasonic autonomous detection of a leak in a component are disclosed using at least one source sensor, at least one ambient sensor and a processor. Based upon the detection of high frequency sounds from the sensor, the processor can determine whether or not a leak is present.

### CROSS-REFERENCE TO RELATED APPLICATIONS

This application claims priority to U.S. Provisional Application Ser. No. 62/475,959 filed Mar. 24, 2017, which is herein incorporated by reference in its entirety.

### BACKGROUND

### Field

The presently disclosed subject matter relates to a system and method for the ultrasonic autonomous detection of leaks in a process component.

### Description of Related Art

There is a need to prevent leaks of process materials from process components in a refinery or petrochemical processing facility and quickly remedy a leak if one were to occur. The components may be valves, compressors, pumps and the like. The current standard for leak detection in refinery and petrochemical processing facilities is Method 21 from the Environmental Protection Agency entitled “Determination of Volatile Organic Compound Leaks” that involves an individual with a backpack unit containing a pump connected to a hand-held probe. The individual walks from valve to valve sampling the valve packing glands and if the leak is over a threshold (typically >500 ppm) the valve is marked for later repair. These facilities often process volatile organic compounds that have a high vapor pressure at ordinary room temperature. These compounds when released to the atmosphere may create ozone and create atmospheric smog and haze. Typically, components are visually inspected for leaks on a routine basis (e.g., monthly or quarterly). There is a need to increase the number of inspections such that a leak can be detected and repaired within hours compared to days. This will significantly reduce the release of compounds into the atmosphere as well as reduce material loss within the process system within the facility.

Others have attempted to monitor process components, but these systems are complex and are not autonomous standalone systems. For example, U.S. Pat. Nos. 6,675,665 and 6,338,283 to Blazquez Navarro et al. disclose electronic systems for monitoring and continuous surveillance of steam traps, valves and installations using fluids. The systems includes a multi sensor, an electronic analyzer and a receiver. The sensor measures fluid conductivity, pressure and temperature. The sensor also incorporates an ultrasonic sensor which detects ultrasounds generated in the steam trap or valve. The electronic analyzer continuously controls the status (pressure, temperature) and conductivity of fluid, supplying optical, acoustic and digital information, in situ or from a remote point, in accordance with the results of analysis carried out. The receiver centralizes and processes the signals emitted by the analyzer. The analyzer electronic circuits are fed by batteries recharged through photovoltaic cells incorporated in the equipment. These systems, however, are not autonomous and require multiple inputs relating to fluid conductivity, pressure and temperature to monitor.

There is a need for an autonomous system that can regularly monitor components in a refinery or petrochemical facility to determine whether or not a leak is present on a regular basis while avoiding the above described deficiencies.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a system for the ultrasonic autonomous detection of a leak in a component is disclosed. The system includes at least one source sensor, at least one ambient sensor and a processor operatively connected to the at least one source sensor and the at least one ambient sensor. The at least one source sensor is positioned to detect a high frequency sound that may be emitted from the component when a leak is present in the component. The at least one ambient sensor is spaced from the component and is positioned to detect the high frequency sound that may be emitted from the component when a leak is present in the component. The processor operates the at least one source sensor and the at least one ambient sensor and determines whether or not a leak in the component is present in response to a high frequency sound detected by at least one of the at least one source sensor and the at least one ambient sensor. The processor determines that a leak is present in the component when a high frequency sound is detected by the at least one source sensor but not the at least one ambient sensor. The processor determines that a leak is present in the component when a high frequency sound is detected by the at least one source sensor and another high frequency sound having a different frequency is detected by the at least one ambient sensor. The processor determines that a leak is not present in the component when a high frequency sound is detected by the at least one source sensor and another high frequency sound having substantially the same frequency as the high frequency sound is detected by the at least one ambient sensor. The processor is operatively connected to the alarm to operate the alarm in response to a determination that a leak is present in the component. The processor periodically operates the at least one source sensor and the at least one ambient sensor to determine whether or not a high frequency sound is present.

To achieve these and other advantages and in accordance with the purpose of the disclosed subject matter, as embodied and broadly described, a method for the ultrasonic autonomous detection of a leak in a component is disclosed. The method includes the steps of detecting whether or not a high frequency sound is present in a vicinity of the component using at least one source sensor, detecting whether or not another high frequency sound is present in an area spaced from the component using at least one ambient sensor, determining whether or not a leak in the component is present in response to a high frequency sound detected by at least one of the at least one source sensor and the at least one ambient sensor, and issuing an alarm in response to a determination that a leak is present in the component. The at least one source sensor is positioned to detect the high frequency sound that may be emitted from the component when a leak is present in the component. The at least one ambient sensor is positioned to detect the high frequency sound that may be emitted from the component when a leak is present in the component. The determination of whether or not a leak in the component is present in response to a high frequency sound detected by at least one of the at least one source sensor and the at least one ambient sensor is performed using a processor. The processor is operatively connected to the at least one source sensor and the at least one ambient sensor. The processor determines that a leak is present in the component when a high frequency sound is detected by the at least one source sensor but not the at least one ambient sensor. The processor determines that a leak is present in the component when a high frequency sound is detected by the at least one source sensor and another high frequency sound having a different frequency is detected by the at least one ambient sensor. The processor determines that a leak is not present in the component when a high frequency sound is detected by the at least one source sensor and another high frequency sound having substantially the same frequency as the high frequency sound is detected by the at least one ambient sensor.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a schematic view of a leak in a component.

FIG. 2 is a schematic view of a system for the ultrasonic autonomous detecting leaks in a component in accordance with one embodiment of the presently disclosed subject matter.

FIG. 3 is a schematic view of another system for the ultrasonic autonomous detecting leaks in a component in accordance with another embodiment of the presently disclosed subject matter.

FIG. 4 is a flow diagram of a method for ultrasonic autonomous detecting leaks in a component in accordance with the presently disclosed subject matter.

### DETAILED DESCRIPTION OF THE PREFERRED EMBODIMENT

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

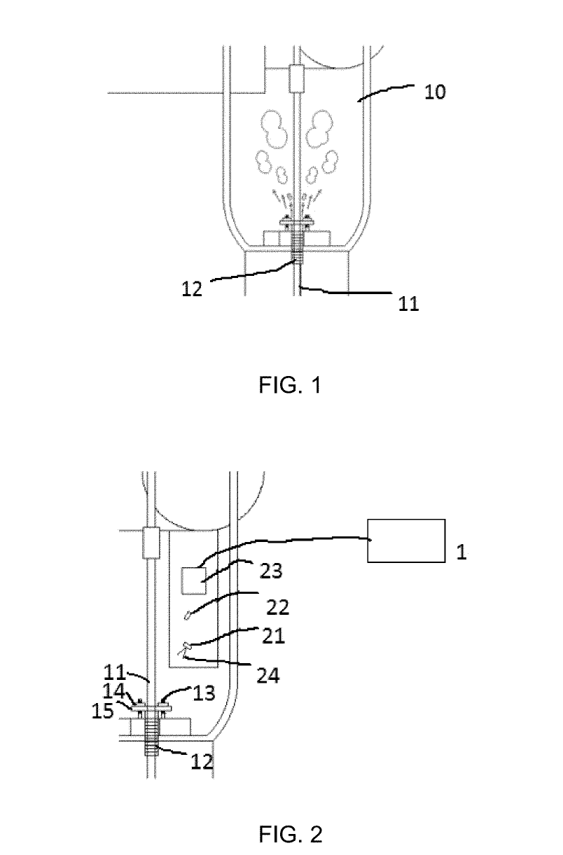

The presently disclosed subject matter will be disclosed in connection with a component 10, which for purposes of illustration is a valve having a valve stem 11, packing washers 12, packing adjustment stud 13, packing adjustment nut 14 and packing adjustment plate 15. By the adjusting the packing adjustment plate 15 through operation of the packing adjustment nut 14, the packing washers 12 can be compressed to present material from escaping around the valve stem 11. FIG. 1 illustrates a leak around the valve stem 11 of a component 10. When this occurs, a high frequency sound is emitted from the leak site. It is contemplated that the application of the presently disclosed subject matter is not limited to valves, rather it is contemplated that the component may be valve, compressor or pump that may be susceptible to leaks.

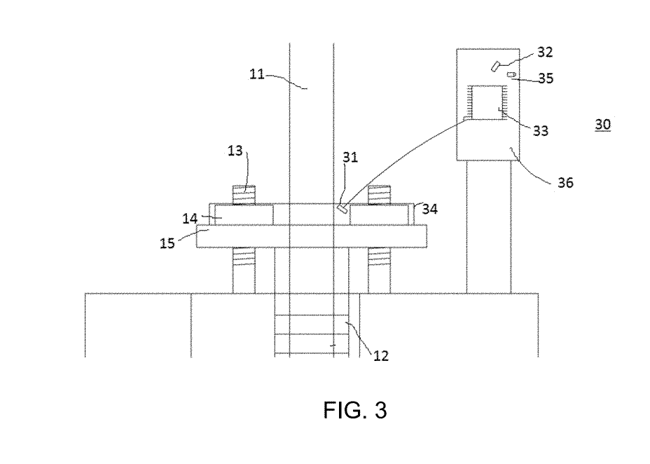

FIGS. 2 and 3 illustrate exemplary embodiments of the ultrasonic leak detection system in accordance with the presently disclosed subject matter.

A leak detection system 20 according to one embodiment will described now in connection with FIG. 2. The system 20 includes at least one source sensor 21 that is capable of detecting high frequency sound emitted from the component 10. The frequency of the sound is typically higher than what can be detected by human ears. The at least one source sensor 21 is preferably an ultrasonic microphone or mic that is capable of detecting high frequency sound (in the ultrasonic range >30kHz) emitted from the component 10. The source sensor 21 is preferably equipped with a unidirectional horn or shield to limit or block ambient ultrasonic sound. The system 20 also includes at least one ambient sensor 22 that is capable of detecting ambient ultrasonic sound in the vicinity of the system 20. The at least one ambient sensor 22 is preferably an ultrasonic microphone or mic that is capable of detecting ambient ultrasonic sound. Each of the sensors 21 and 22 are operatively coupled to a processor 23. The processor 23 receives signals from the sensors 21 and 22 and processes the signals in order to determine whether or not a leak is detected at the component 10. The sensor 21 preferably includes a directional horn 24 to focus the sensing operation of the sensor on the component 10.

The processor 23 compares the signal(s) from the at least one source sensor 21 with the signal(s) from the at least one ambient sensor 22. The processor 23 determines whether or not a high frequency sound was detected by the source sensor 21. If a high frequency sound is detected, the processor 23 then determines whether or not a high frequency sound was also detected by the ambient sensor 22. If no high frequency sound is detected by the at least one ambient sensor 22, then the processor 23 that the component 10 may be leaking. If high frequency sound was also detected by the ambient sensor 22, then processor 23 determines whether or not it has a similar frequency to the high frequency sound detected by the at least one source sensor 21. If the frequencies are similar, then the processor 23 determines that (i) the sound is ambient and (ii) no leak is detected in the component 10. If the frequencies are not similar, then the processor 23 determines that (i) the sound is not ambient and (ii) the component 10 may be leaking.

The processor 23 is operatively connected to a control system 1. The control system 1 is used to control the operation of the components associated with a particular process. If the processor 23 determines that a leak in present in the component 10, a signal is sent to the control system 1 to trigger an alarm alerting the operator of the leak in the component 10. The alarm will remain triggered until the component 10 can be inspected to confirm the presence of a leak and the necessary maintenance operation is performed. At which time, the system 20 is reset to continue monitoring the component 10. It is also contemplated that the control signal may be sent to a remote device (e.g. a cell phone or other hand held device or tablet) to alert the operator of the leak in the component.

The sensors 21 and 22 and the processor 23 maybe battery operated or hard wired to an electrical source. Additionally, it is contemplated that the processor 23 may be hard wired directly to the control system 1. It is also contemplated that the processor 23 may be operatively coupled with the control system 1 by radio signal, in which case, the processor 23 includes a transmitter to transmit signals to the control system 1. The radio signal may also be transmitted to a hand held device to alert the operator of a leak in the component 10. The sensors 21 and 22 may be hard wired directly to the processor 23. Alternatively, it is also contemplated that the sensors 21 and 22 may be operatively coupled with the processor 23 by radio signal. The processor 23 preferably includes a clock with a timer such that processor 23 may initiate the sensing operations by the sensors 21 and 22 at periodic intervals. It is contemplated that the sensors 21 and 22 detect for high frequency sounds at least once every thirty (30) minutes whereby the systems 20 or 30 detect for leaks at least 48 times in a 24 hour cycle.

A leak detection system 30 according to another embodiment will described now in connection with FIG. 3. The system 30 includes at least one source sensor 31 that is capable of detecting high frequency sound emitted from the component 10. The at least one source sensor 31 is preferably an ultrasonic microphone or mic that is capable of detecting high frequency sound (in the ultrasonic range >30 kHz) emitted from the component 10. The source sensor 31 is preferably located adjacent the component 10. If the component 10 is a valve, the at least one source sensor 31 is located in the vicinity of a valve stem 11. A cover 34 may be provided to isolate or reduce the exposure of the at least one source sensor 31 to ambient noise. The system 30 also includes at least one ambient sensor 32 that is capable of detecting ambient ultrasonic sound in the vicinity of the sensor 32. The at least one ambient sensor 32 is preferably an ultrasonic microphone or mic that is capable of detecting ambient ultrasonic sound. The at least one ambient sensor 32 is preferably remotely located from the at least one source sensor 31. Each of the sensors 31 and 32 are operatively coupled to a processor 33. The processor 33 receives signals from the sensors 31 and 32 and processes the signals in order to determine whether or not a leak is detected at the component 10. The at least one ambient sensor 32 and the processor 33 may be mounted to a remote unit 34, which may contain a power source (e.g., a battery) for operating the sensors and the processor 33. The remote unit 36 may also include an alarm 35. The alarm 35 may include an LED to provide a visual indication of a leak when is detected by the system 30. The alarm may also be located on a remote device (e.g. a cell phone or other hand held device or tablet) to alert the operator of the leak in the component. With such an arrangement, the processor 33 transmits a signal to the remote device to provide an alarm on the remote device. It is contemplated that the alarm may be visual, audible or both.

The processor 33 compares the signal(s) from the at least one source sensor 31 with the signal(s) from the at least one ambient sensor 32. The processor 33 determines whether or not a high frequency sound was detected by the source sensor 31. If a high frequency sound is detected, the processor 33 then determines whether or not a high frequency sound was also detected by the ambient sensor 32. If no high frequency sound is detected by the at least one ambient sensor 32, then the processor 33 that the component 10 may be leaking. If high frequency sound was also detected by the ambient sensor 32, then processor 33 determines whether or not it has a similar frequency to the high frequency sound detected by the at least one source sensor 31. If the frequencies are similar, then the processor 33 determines that (i) the sound is ambient and (ii) no leak is detected in the component 10. If the frequencies are not similar, then the processor 33 determines that (i) the sound is not ambient and (ii) the component 10 may be leaking.

The processor 33 may also be operatively connected to a control system 1. The control system 1 is used to control the operation of the components associated with a particular process. If the processor 33 determines that a leak in present in the component 10, the alarm 35 is triggered. Additionally, a signal may be sent to the control system 1 to trigger an additional alarm on an operator control panel alerting the operator of the leak in the component 10. In either case, the alarm 35 or the alarm on the control panel will remain triggered until the component 10 can be inspected to confirm the presence of a leak and the necessary maintenance operation is performed. At which time, the system 30 is reset to continue monitoring the component 10.

The sensors 31 and 32 and the processor 33 maybe battery operated or hard wired to an electrical source. The processor 33 may be hard wired directly to the control system 1 or operatively coupled with the control system 1 by radio signal. The sensors 31 and 32 may be hard wired directly to the processor 33, as shown in FIG. 3. Alternatively, it is also contemplated that the sensors 31 and 32 may be operatively coupled with the processor 33 by radio signal.

The presently disclosed subject matter provides advantages over the prior art. The use of multiple sensors (i.e., source sensors and ambient sensors) to sample source and ambient noise aids in the elimination of false positive alarms. Additionally, systems 20 and 30 provide for regular monitoring in a standalone autonomous system, which would alarm (locally or remotely) as soon as a leak occurs. It is contemplated that the systems 20 and 30 could take up to 48 sensing measurements within a twenty four hour cycle. Over a five year period (based upon an expected battery life), the systems in accordance with the presently disclosed subject matter could take 87,000 measurements illustrating both leak and non-leak events. The measured data may be used to estimate when a component might leak (e.g., estimate when a valve packing may start to fail). Based upon the measurements from the sensors, it may also be possible to determine the severity of the leak. For example, if the leak medium (e.g., hydrogen, H₂S, etc) and the process conditions (e.g., process temperature, pressure, etc.) are known it is possible to determine leak size data (ppm).

Additionally, the compounds that are moved through the components of a refinery or petrochemical processing facility in many cases are inherently dangerous, and these dangers can be long term and short term in nature. The materials may be explosive in nature or have detrimental health effects to operators and facility personnel if exposed to those materials. The present disclosed subject matter can provide suitable alarms such that these individuals can remain out of harms way or don the appropriate equipment to limit exposure to the compounds. The presently disclosed subject matter has been found to be effective in identifying leaks at the 500 PPM level.

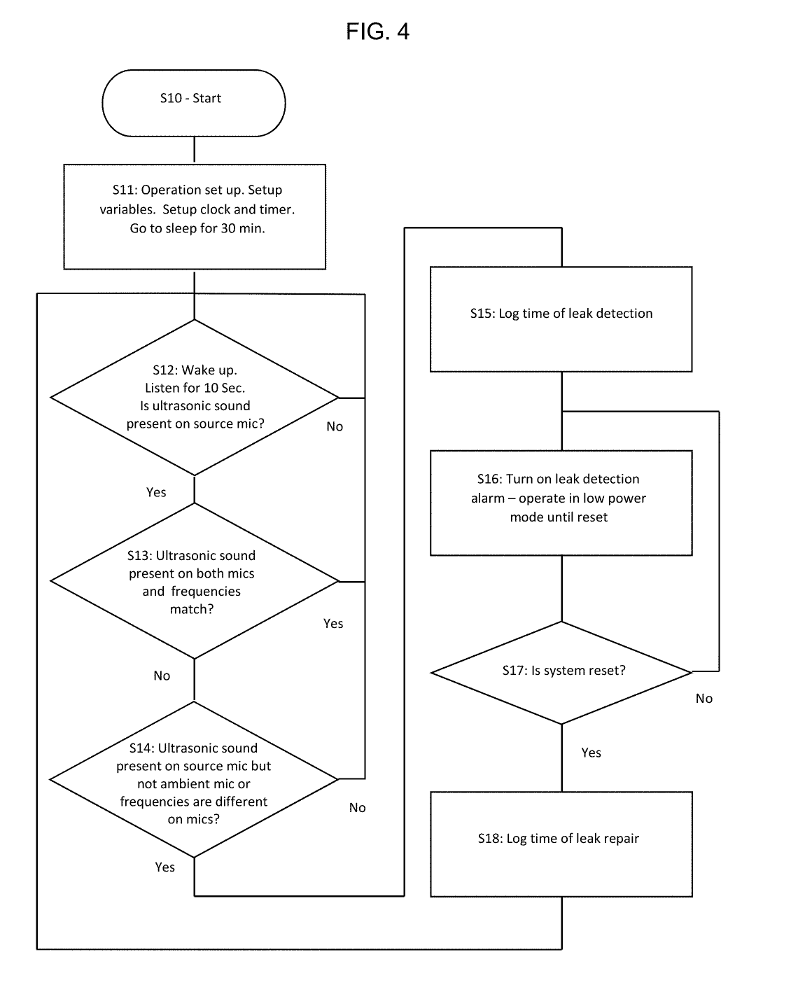

A method of the ultrasonic autonomous detection of leaks in a component in accordance with the presently disclosed subject matter will now be described in connection with FIG. 4 and the system 20, 30. In step S10, the leak detection methodology is initiated. In step S11, the system 20, 30 is setup such that the at least one source sensor 21, 31 and the at least one ambient sensor 22, 32 are properly configured and located to detect high frequency sounds. Once configured, the processor 23, 33 enters a sleep mode for thirty (30) minutes. While thirty minutes is the preferred duration for the sleep mode, it is contemplated that the sleep mode duration may be extended or shortened based upon the number detection cycles desired.

In step S12, the processor 23, 33 wakes up from the sleep mode. The source sensor 21, 31 and the ambient sensor 22, 32 listen for a period of ten (10) seconds to detect whether or not a high frequency sound is present. If the processor 23, 33 determines that no high frequency sound was detected by the at least one source sensor 21, 31, the processor 23, 33 determines that no leak in the component 10 is detected. The processor 23, 33 returns to sleep mode for another thirty minutes where upon processor reawakens to repeat the detection operation for ten seconds. Step S12 is repeated until a high frequency sound is detected by the at least one source sensor 21, 31 whereby the operation proceeds to step S13.

In step S13, the processor 23, 33 determines whether or not a high frequency sounds was also detected by the at least one ambient sensor 22, 32. If the processor 23, 33 determines that a high frequency sound was also detected by the at least one ambient sensor 22, 32, and the frequencies of the sounds detected by the source sensor and the ambient sensor match (i.e., approximately the same), the processor 23, 33 determines that (i) the high frequency sound is attributed to ambient sound and (ii) no leak in the component 10 is detected. The processor 23, 33 returns to sleep mode for another thirty minutes where upon processor reawakens to repeat the detection operation in step S12. If the processor 23, 33 determines that either (i) no high frequency sound was also detected by the at least one ambient sensor 22, 32 or (ii) that a high frequency sound was detected but it does not match the frequencies of the sounds detected by the source sensor, then processor determines that a leak may be present and the operation proceeds to step S14. In the event that measured frequencies from the source sensor and ambient sensor are approximately the same (which would be indicative that no leak is present), but the measured frequencies exceed a predetermined threshold, the processor 23, 33 will determine that the exceeding of the threshold is indicative of a leak in the component 10 whereby the operation will proceed to step S15.

In step S14, if the processor 23, 33 determines that a high frequency sound is detected on the source sensor but not the ambient source, then a leak is detected and the operation proceeds to step S15. If the processor 23, 33 determines that a high frequency sound is detected on the source sensor and the ambient source, but with differing frequencies, then a leak is detected and the operation proceeds to step S15. If the processor 23, 33 determines that a high frequency sound is detected on the source sensor and the ambient source, but with approximately the same frequencies (below a predetermined threshold), then a leak is not detected, sound is attributed to ambient sound and the operation returns to step S12. The processor 23, 33 returns to sleep mode for another thirty minutes where upon processor reawakens to repeat the detection operation in step S12. If the same frequencies are above a predetermined threshold, then the operation will proceed to step S15.

In step S15, the time of the leak detection is logged. The operation will proceed to step S16 where the processor turns on the alarm 35 and/or forwards a signal to the control system 1 to initiate an alarm signal on the control panel to alert the operator. Once an alarm has been signaled, the system 20, 30 will enter a low power mode whereby additional detections are not made until the system 20, 30 has been reset. The operation will proceed to step S17. If the system 20, 30 is not reset, the operation will return to step S16. After the inspection/repair of the leak, the system 20, 30 can be reset. The processor 23, 33 will return to a sleep mode and the operation of the system 20, 30 will return to step S12 whereby the detection process initiated in step S12 will be repeated.

### ADDITIONAL EMBODIMENTS

Additionally or alternately, the invention can include one or more of the following embodiments.

### Embodiment 1

A system for the ultrasonic autonomous detection of a leak in a component system comprising at least one source sensor and at least one ambient sensor. The at least one source sensor is positioned to detect a high frequency sound that may be emitted from the component when a leak is present in the component. The at least one ambient sensor is spaced from the component and is positioned to detect the high frequency sound that may be emitted from the component when a leak is present in the component. The system further includes a processor that is operatively connected to the at least one source sensor and the at least one ambient sensor. The processor operates the at least one source sensor and the at least one ambient sensor and determines whether or not a leak in the component is present in response to a high frequency sound detected by at least one of the at least one source sensor and the at least one ambient sensor.

### Embodiment 2

The system according to Embodiment 1, wherein the at least one source sensor is microphone.

### Embodiment 3

The system according to any one of the preceding Embodiments, wherein the at least one source sensor is located adjacent the component.

### Embodiment 4

The system according to Embodiment 3, further comprising a cover to cover the at least one source sensor and isolate the at least one source sensor from ambient sounds.

### Embodiment 5

The system according to Embodiment 1or Embodiment 2, wherein the at least one source sensor is spaced from the component.

### Embodiment 6

The system according to Embodiment 5, further comprising a directional horn to isolate the at least one source sensor from ambient sounds.

### Embodiment 7

The system according to anyone of the preceding Embodiments, wherein the processor determines that a leak is present in the component when a high frequency sound is detected by the at least one source sensor but not the at least one ambient sensor.

### Embodiment 8

The system according to Embodiment 7, further comprising an alarm, wherein the processor is operatively connected to the alarm to operate the alarm in response to a determination that a leak is present in the component.

### Embodiment 9

The system according to anyone of the preceding Embodiments, wherein the processor determines that a leak is present in the component when a high frequency sound is detected by the at least one source sensor and another high frequency sound having a different frequency is detected by the at least one ambient sensor.

### Embodiment 10

The system according to Embodiment 9, further comprising an alarm, wherein the processor is operatively connected to the alarm to operate the alarm in response to a determination that a leak is present in the component.

### Embodiment 11

The system according to anyone of the preceding Embodiments, wherein the processor determines that a leak is not present in the component when a high frequency sound is detected by the at least one source sensor and another high frequency sound having substantially the same frequency as the high frequency sound is detected by the at least one ambient sensor.

### Embodiment 12

The system according to any one of the preceding Embodiments, wherein the processor periodically operates the at least one source sensor and the at least one ambient sensor to determine whether or not a high frequency sound is present.

### Embodiment 13

The system according to Embodiment 12, wherein the processor periodically operates the at least one source sensor and the at least one ambient sensor are predetermined intervals.

### Embodiment 14

A method for the ultrasonic autonomous detection of a leak in a component comprising the steps of detecting whether or not a high frequency sound is present in a vicinity of the component using at least one source sensor, wherein the at least one source sensor is positioned to detect the high frequency sound that may be emitted from the component when a leak is present in the component; detecting whether or not another high frequency sound is present in an area spaced from the component using at least one ambient sensor, wherein the at least one ambient sensor is positioned to detect the high frequency sound that may be emitted from the component when a leak is present in the component; determining whether or not a leak in the component is present in response to a high frequency sound detected by at least one of the at least one source sensor and the at least one ambient sensor; and issuing an alarm in response to a determination that a leak is present in the component.

### Embodiment 15

The method according to Embodiment 14, wherein determining whether or not a leak in the component is present in response to a high frequency sound detected by at least one of the at least one source sensor and the at least one ambient sensor is performed using a processor, wherein the processor is operatively connected to the at least one source sensor and the at least one ambient sensor.

### Embodiment 16

The method according to Embodiment 15, wherein the processor determines that a leak is present in the component when a high frequency sound is detected by the at least one source sensor but not the at least one ambient sensor.

### Embodiment 17

The method according to Embodiment 15 or Embodiment 16, wherein the processor determines that a leak is present in the component when a high frequency sound is detected by the at least one source sensor and another high frequency sound having a different frequency is detected by the at least one ambient sensor.

### Embodiment 18

The method according to any one of Embodiments 15-17, wherein the processor determines that a leak is not present in the component when a high frequency sound is detected by the at least one source sensor and another high frequency sound having substantially the same frequency as the high frequency sound is detected by the at least one ambient sensor.

### Embodiment 19

The method according to any one of Embodiments 15-18, wherein detecting whether or not a high frequency sound is present in a vicinity of the component using at least one source sensor and detecting whether or not another high frequency sound is present in an area spaced from the component using at least one ambient sensor are performed at predetermined periodic intervals.

### Embodiment 20

The method according to Embodiment 19, wherein the predetermined periodic intervals occur at least once every 30 minutes if a leak has not been previously detected.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A system for the ultrasonic autonomous detection of a leak in a component, the system comprising:
at least one source sensor, wherein the at least one source sensor is positioned to detect a high frequency sound that may be emitted from the component when a leak is present in the component;
at least one ambient sensor, wherein the at least one ambient sensor is spaced from the component and is positioned to detect the high frequency sound that may be emitted from the component when a leak is present in the component; and
a processor operatively connected to the at least one source sensor and the at least one ambient sensor, wherein the processor operates the at least one source sensor and the at least one ambient sensor and determines whether or not a leak in the component is present in response to a high frequency sound detected by at least one of the at least one source sensor and the at least one ambient sensor.

2. The system according to claim 1, wherein the at least one source sensor is microphone.

3. The system according to claim 1, wherein the at least one source sensor is located adjacent the component.

4. The system according to claim 3, further comprising a cover to cover the at least one source sensor and isolate the at least one source sensor from ambient sounds.

5. The system according to claim 1, wherein the at least one source sensor is spaced from the component.

6. The system according to claim 5, further comprising a directional horn to isolate the at least one source sensor from ambient sounds.

7. The system according to claim 1, wherein the processor determines that a leak is present in the component when a high frequency sound is detected by the at least one source sensor but not the at least one ambient sensor.

8. The system according to claim 7, further comprising an alarm, wherein the processor is operatively connected to the alarm to operate the alarm in response to a determination that a leak is present in the component.

9. The system according to claim 8, wherein the alarm is located on a remote device and the processor transmits a signal to the alarm in response to a determination that a leak is present in the component.

10. The system according to claim 1, wherein the processor determines that a leak is present in the component when a high frequency sound is detected by the at least one source sensor and another high frequency sound having a different frequency is detected by the at least one ambient sensor.

11. The system according to claim 10, further comprising an alarm, wherein the processor is operatively connected to the alarm to operate the alarm in response to a determination that a leak is present in the component.

12. The system according to claim 11, wherein the alarm is located on a remote device and the processor transmits a signal to the alarm in response to a determination that a leak is present in the component.

13. The system according to claim 1, wherein the processor determines that a leak is not present in the component when a high frequency sound is detected by the at least one source sensor and another high frequency sound having substantially the same frequency as the high frequency sound is detected by the at least one ambient sensor.

14. The system according to claim 1, wherein the processor periodically operates the at least one source sensor and the at least one ambient sensor to determine whether or not a high frequency sound is present.

15. The system according to claim 14, wherein the processor periodically operates the at least one source sensor and the at least one ambient sensor are predetermined intervals.

16. A method for the ultrasonic autonomous detection of a leak in a component, the method comprising the steps of:
detecting whether or not a high frequency sound is present in a vicinity of the component using at least one source sensor, wherein the at least one source sensor is positioned to detect the high frequency sound that may be emitted from the component when a leak is present in the component;
detecting whether or not another high frequency sound is present in an area spaced from the component using at least one ambient sensor, wherein the at least one ambient sensor is positioned to detect the high frequency sound that may be emitted from the component when a leak is present in the component;
determining whether or not a leak in the component is present in response to a high frequency sound detected by at least one of the at least one source sensor and the at least one ambient sensor; and
issuing an alarm in response to a determination that a leak is present in the component.

17. The method according to claim 16, wherein determining whether or not a leak in the component is present in response to a high frequency sound detected by at least one of the at least one source sensor and the at least one ambient sensor is performed using a processor, wherein the processor is operatively connected to the at least one source sensor and the at least one ambient sensor.

18. The method according to claim 17, wherein the processor determines that a leak is present in the component when a high frequency sound is detected by the at least one source sensor but not the at least one ambient sensor.

19. The method according to claim 17, wherein the processor determines that a leak is present in the component when a high frequency sound is detected by the at least one source sensor and another high frequency sound having a different frequency is detected by the at least one ambient sensor.

20. The method according to claim 17, wherein the processor determines that a leak is not present in the component when a high frequency sound is detected by the at least one source sensor and another high frequency sound having substantially the same frequency as the high frequency sound is detected by the at least one ambient sensor.

21. The method according to claim 16, wherein detecting whether or not a high frequency sound is present in a vicinity of the component using at least one source sensor and detecting whether or not another high frequency sound is present in an area spaced from the component using at least one ambient sensor are performed at predetermined periodic intervals.

22. The method according to claim 21, wherein the predetermined periodic intervals occur at least once every 30 minutes if a leak has not been previously detected.
